(19) United States
(12) Patent Application Publication
(10) Pub. No.: US 2009/0211141 A1
(43) Pub. Date: Aug. 27, 2009

(54) Fishing rod holder

(75) Inventor: Wesley C. Marcus, St. Peter, MN (US)

Correspondence Address: REINHART BOERNER VAN DEUREN P.C., 2215 PERRYGREEN WAY, ROCKFORD, IL, 61107, US

(73) Assignee: Johnson Outdoors Inc.

(21) Appl. No.: 12/072,198

(22) Filed: Feb. 25, 2008

(51) Int. Cl. A01K 97/10

(52) U.S. Cl. 43/21.2

(57) ABSTRACT

An adjustable fishing rod holder assembly has a base assembly, a holder, and a latching assembly. The base assembly is adapted to be mounted to a surface. The holder is adapted to removably receive the handle or butt end of a fishing rod. The holder is pivotally coupled to the base assembly to allow the angle of inclination of the holder to be adjusted. The latching assembly is configured to lock the holder in multiple inclination angle positions with respect to the base assembly.

### BACKGROUND

The present invention relates to a fishing rod holder. More specifically, the present invention relates to a fishing rod holder assembly that allows the fishing rod holder to be mounted in a variety of locations and manners, and allows the position of the rod holder assembly to be angularly adjusted about multiple axes.

Many variations of fishing rod holders are known in the art. Fishing rod holders allow the fishing rod to be held in a fishing position while the angler performs other tasks in addition to fishing. Many fishing vessels have a track or tracks that allow anglers to mount and fish simultaneously with more than one fishing rod. Many rod holders are configured to mount in a stationary position within the track. The track is generally permanently affixed to the vessel making it difficult to change the mounting location and the mounting plane of the rod holder(s) in response to fishing conditions such as the boat's speed, the current or tide strength, the size, angle and proximity of other fishing rods, and/or the fishing technique employed. Therefore, a fishing rod holder that is affixed to a track (or that is difficult to adjust in a track) limits the number of rods that may be effectively simultaneously fished with, as only so many rods can be mounted in one track without the fishing conditions eventually crossing the rods' lines.

Likewise, with many fishing rod holders it is difficult or impossible to angularly adjust the position of the holder. If the fishing rod holder is angularly adjustable, it is generally adjustable only about a single axis of rotation. The angular adjustment process may involve the loosening and tightening of fasteners with tools, which is cumbersome and time consuming. If the rod holder uses fasteners that must be loosened and retightened, it is generally difficult for the angler to quickly adjust the rod's inclination in response to most of the stimuli experienced once fishing commences. In addition to the fishing conditions discussed previously, when a fish strikes the angler's bait, many fishing rod holders require the angler to remove the fishing rod from the holder, in order to fight the fish. Difficulties in removing the fishing rod from the rod holder can allow some fish to be lost. Thus, the limited angular adjustability (or lack of angular adjustability) of many fishing rod holders limits the number and effectiveness of the fishing rods being used.

### SUMMARY

An adjustable fishing rod holder assembly has a base assembly, a holder, and a latching assembly. The base assembly is adapted to be mounted to a surface. The holder is adapted to removably receive the handle or butt end of a fishing rod. The holder is pivotally coupled to the base assembly to allow the angle of inclination of the holder to be adjusted. The latching assembly is configured to lock the holder in multiple inclination angle positions with respect to the base assembly. In another embodiment, the base assembly includes a rotational assembly to rotate or swing the holder. The rotational assembly may be adapted to lock the holder in multiple rotational positions.

### BRIEF DESCRIPTION OF THE DRAWINGS

FIG. 1 is an exploded view of one embodiment of a fishing rod holder assembly in accordance with the present invention.

FIG. 1A is a left side view of the assembled fishing rod holder assembly from FIG. 1.

FIG. 1B is a right side view of the assembled fishing rod holder assembly from FIG. 1.

FIG. 2 is an elevated perspective view of one embodiment of the fishing rod holder assembly including a base plate and a channel mounted to a surface.

FIG. 3 is an elevated perspective view of the fishing rod holder assembly from FIG. 1 mounted to a surface.

FIG. 4 is an elevated perspective view of another embodiment of the fishing rod holder assembly including a lower disc mounted to a surface.

FIG. 5 is an elevated perspective view of another embodiment of the fishing rod holder assembly mounted to a surface.

FIG. 6 is a perspective view of the fishing rod holder assembly from FIG. 1 in an interlocked position between its horizontal and vertical pivotal range.

FIG. 7 is a perspective view of the fishing rod holder assembly from FIG. 5 shown in an upright interlocked position at the upper end of its vertical pivotal range.

### DETAILED DESCRIPTION

1. Overview of the Assembly 10

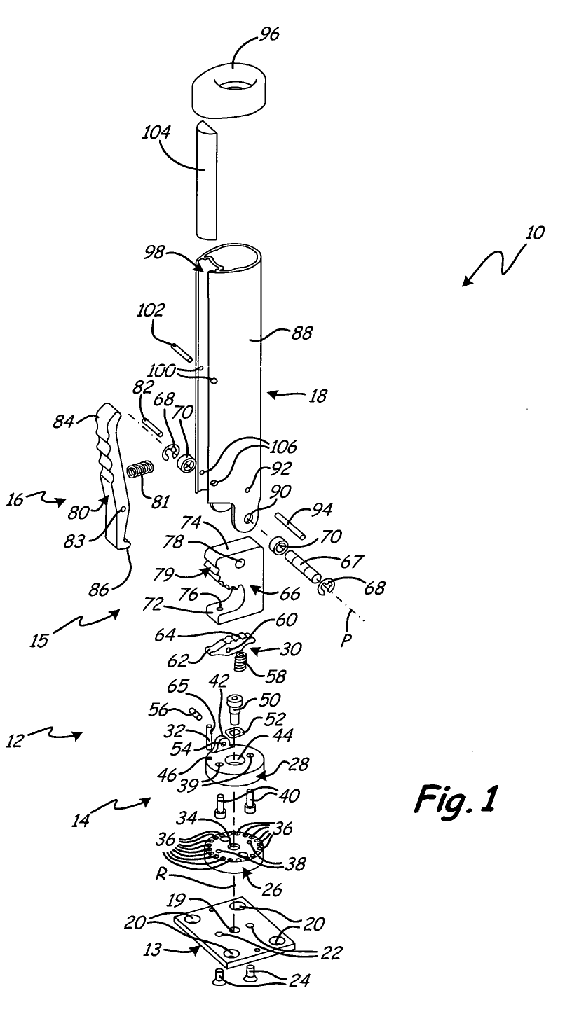

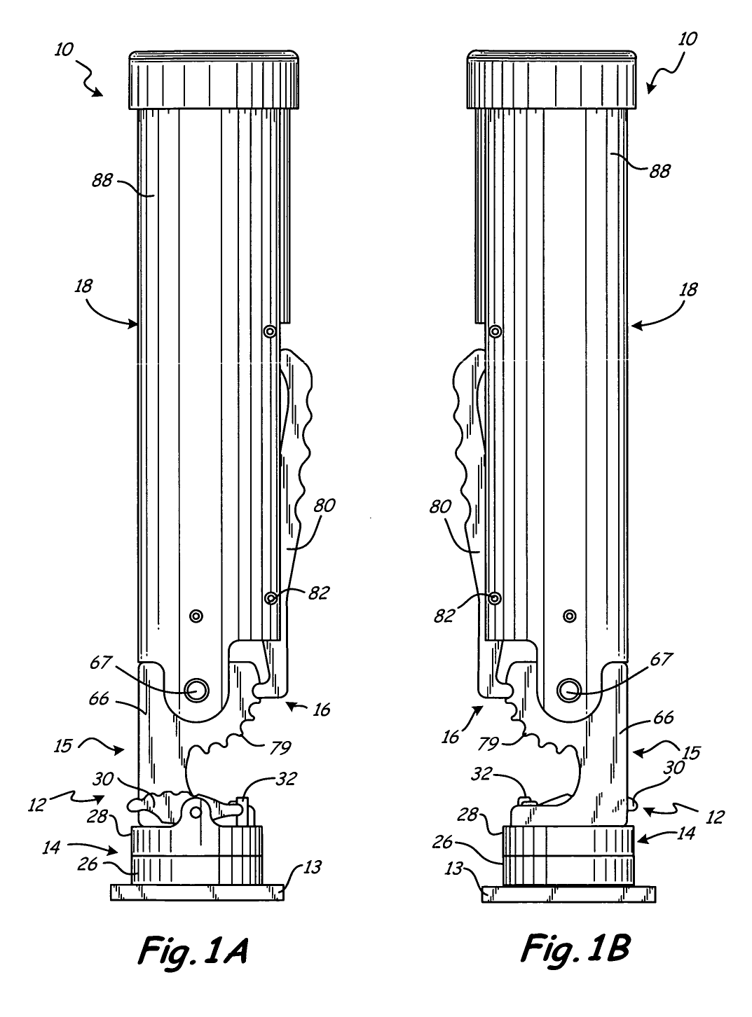

FIG. 1 shows an exploded view of an exemplary embodiment of a fishing rod holder assembly 10. FIGS. 1A and 1B show left and right side views of the fishing rod holder assembly 10 as assembled. The fishing rod holder assembly 10 includes a base assembly 12 (which includes a base plate 13, a rotational assembly 14, and a pivot assembly 15), a latching assembly 16, and a holder tube 18.

The base plate 13 includes a first bore 19, mounting apertures 20, disc holes 22, and screws 24.

The rotational assembly 14 includes a lower disc or puck 26, an upper disc or puck 28, a locking lever 30, and a locking pin 32. The lower disc 26 further includes a second bore 34, apertures 36, and holes 38. The upper disc 28 includes counter bored holes 39, cap screws 40, a pivot flange 42, a third bore 44, a locking aperture 46, a shoulder bolt 50, a wave washer 52, a dowel aperture 54, a dowel pin 56, and a first bias spring 58. The locking lever 30 includes an aperture 60, a nose portion 62, a ribbed portion 64, and a notch 65.

The pivot assembly 15 includes a pivot base 66, a pivot pin 67, e-clips 68, and spacer bushings 70. The pivot base 66 is comprised of a base portion 72 and a upper portion 74. The base portion 72 includes mounting holes 76. The upper portion 74 includes a pivot aperture 78.

The latch assembly 16 includes detents 79 (formed in the upper portion of 74 of the pivot base 66), a latch lever 80, a second bias spring 81, and a latch pivot pin 82. The latch lever 80 includes a pivot hole 83, a latch handle portion 84, and a pawl 86.

The holder tube 18 includes a shaft 88, a pivot aperture 90, a lower gimbal aperture 92, a lower gimbal pin 94, a tube cap 96, a lever channel 98, an upper gimbal aperture 100, a upper gimbal pin 102, an insert 104, and a latch lever pivot aperture 106.

The base assembly 12 is adapted to mount the fishing rod holder assembly 10 to a surface of a fishing vessel. The base assembly 12 is selectively engaged by the latching assembly 16 and is pivotally coupled to the holder tube 18. The base assembly 12 may be configured to be angularly adjustable about a rotational axis R, and is adapted to allow the angle of inclination of the holder tube 18 to be adjusted about a pivot axis P. The latching assembly 16 is configured to lock the holder tube 18 in multiple inclination angle positions relative to the base assembly 12. The holder tube 18 is adapted to removably receive the handle or butt end of a fishing rod.

More specifically, the base assembly 12 may include the base plate 13, which is adapted to mount directly to the vessel surface, or may be received by and secured to a channel. In another embodiment; the base assembly 12 includes the rotational assembly 14, which may be secured to the base plate 13, and the pivot assembly 15, which is secured to the rotational assembly 14. The pivot assembly 15 is selectively engaged by the latching assembly 16 and is pivotally coupled to the holder tube 18.

The rotational assembly 14 is adapted to swing or rotate the holder tube 18 about the generally vertical rotational axis R. The rotational assembly 14 may be configured to interlock with a stationary portion of itself to lock the holder tube 18 in multiple positions about the generally vertical rotational axis R. The pivot assembly 15 is adapted to allow the angle of inclination of the holder tube 18 to be adjusted about the generally horizontal pivot axis P. The latching assembly 16 is configured to lock the holder tube 18 in multiple inclination angle positions relative to the base plate 13, rotational assembly 14, and the pivot assembly 15. The rotational axis R and the pivot axis P allow the fishing rod inserted in the holder tube 18 to be angularly swung and azimuthally inclined. The rotational assembly 14 and the latching assembly 16 allow the assembly 10 to be locked in multiple positions about the axes R and P.

2. The Base Plate 13

The base plate 13 is comprised of a generally flat thin sheet of squarely cut metal, such as aluminum. The base plate 13 has a first bore 19, which extends through the base plate 13 and is generally aligned with the symmetrical vertical axis of the base plate 13 when the base plate 13 is mounted to a surface of the fishing vessel. The base plate 13 has four symmetrically spaced apart mounting apertures 20, which are disposed adjacent each of the four corners of the plate 13. Two counter sunk disc holes 22 also extend upward through the base plate 13.

The first bore 19 may be blank or threaded and receives the lower cylindrical portion of the shoulder bolt 50. The mounting apertures 20 extend through the base plate 13 and are adapted to receive fasteners, which in one embodiment secure the base plate 13 to the gunnels or transom top of the fishing vessel. In FIGS. 1, 1A, and 1B, the two disc holes 22 receive the two screws 24. The screws 24 extend through the base plate 13 to securely mount the lower disc 26 to the base plate 13. Because the disc holes 22 are counter sunk, the holes 22 allow the flat head of the screws 24 to remain generally flush with the bottom surface of the base plate 13.

3. The Rotational Assembly 14

The major components of the rotational assembly include the lower disc 26, the upper disc 28, the locking lever 30, and the locking pin 32. The lower disc 26 interfaces with the upper disc 28. The locking lever 30 pivotally mounts on the upper disc 28 and engages the locking pin 32, which is selectively inserted through the upper disc 28. The upper disc 28 is adapted to be angularly adjustable relative to the lower disc 26 about the first generally vertical rotational axis R. The locking lever 30 and locking pin 32 may be actuated into and out of engagement with the lower disc 26 to lock the upper disc 28 (arid the remainder of the rotational assembly 14) in multiple positions about the generally vertical rotational axis R.

More specifically, the lower disc 26 is cylindrical in shape and includes multiple apertures. One of these apertures is the second bore 34 which extends through the lower disc 26 and is aligned with the symmetrical cylindrical axis of the lower disc 26. In FIG. 1, the lower disc 26 has a plurality of apertures 36 circumferentially arrayed adjacent to the outer edge of the disc 26. The two holes 38 extend through the lower disc 26 and receive the two screws 24, which secure the lower disc 26 to the base plate 13. In another embodiment, the holes 38 may receive fasteners which secure the lower disc 26 directly to the vessel surface. In FIG. 1, the second bore 34 securely receives the lower cylindrical portion of the shoulder bolt 50, which rotatably interconnects the lower disc 26 to the upper disc 28. When one of the apertures 36 is aligned with the locking pin 32, the aperture 36 is capable of receiving the pin 32. This allows the lower disc 26 and upper disc 28 to be interlocked in multiple angular positions.

The upper disc 28 is cylindrical in shape and rotatably interfaces with the lower disc 26. In FIG. 1, two counter bored holes 39 extend through the upper disc 28. The counter bored holes 39 receive the two cap screws 40. The pivot flange 42 extends generally vertically from the top surface of the upper disc 28. The third bore 44 extends through the upper disc 28 and is aligned with the symmetrical cylindrical axis of the upper disc 28. The locking aperture 46 extends through the upper disc 28 and is located adjacent to the outer edge of the disc 28.

The cap screws 40 extend through the upper disc 28 to secure the pivot base 66 to the upper disc 28. The pivot flange 42 is adapted to pivotally couple the locking lever 30 to the top surface of the upper disc 28, which allows the locking lever 30 to be actuated by the angler. The third bore 44 rotatably receives and interfaces with the middle and upper cylindrical portions of the shoulder bolt 50. The locking aperture 46 is configured to movably receive the locking pin 32. The position of the locking aperture 46 in the upper disc 28 allows the locking aperture 46 to be selectively aligned with the apertures 36 as the upper disc 28 pivotally rotates relative to the lower disc 26. In one embodiment, the locking pin 32 may be biased or actuated downward through the locking aperture 46 and is received by one of the apertures 36, which interlocks the lower disc 26 with the upper disc 28. When the locking pin 32 enters one of the apertures 36 the angular adjustment of the upper disc 28 relative to the lower disc 26 is arrested.

In the embodiment shown in FIGS. 1, 1A, and 1B, the first, second and third bores 19, 34 and 44 generally align along the symmetrical vertical axis of the base plate 13, the lower disc 26, and upper disc 28. The shoulder bolt 50 is received by the bores 19, 34, and 44 and defines the generally vertical rotational axis R for the assembly 10. In FIG. 1, the wave washer 52 is disposed between the top head of the shoulder bolt 50 and the top surface of the upper disc 28. The wave washer 52 takes up clearance between these two surfaces, making the rotation of the shoulder bolt 50 smoother. The shoulder bolt 50 is adapted to act as a trunnion to allow for rotation and angular adjustment of the upper disc 28 about the vertical rotational axis R defined by the shoulder bolt 50. Thus, the upper disc 28 and the remainder of the assembly 10 are angularly adjustable to 360 degrees relative to the lower disc 26. In other embodiments, the rod holder assembly 10 may be angularly adjusted along an axis other than the generally vertical axis when the assembly 10 is mounted on the vessel surface.

The dowel aperture 54 extends through the upper portion of the pivot flange 42. The dowel aperture 54 receives the dowel pin 56, which extends through the dowel aperture 54 to pivotally couple the locking lever 30 to the upper disc 28. In one embodiment, the first bias spring 58 contacts the locking lever 30 and the top surface of the upper disc 28. The first bias spring 58 exerts a bias force, which pivotally rotates the locking lever 30 away from the first bias spring 58 about the dowel pin 56.

More specifically, the aperture 60 extends through the middle of the side surfaces of locking lever 30 and pivotally receives the dowel pin 56. The locking lever 30 tapers forward to the front nose portion 62 and extends rearward to the ribbed portion 64. The nose portion 62 is configured to engage the notch 65 on the locking pin 32, which extends generally vertically downward into the locking aperture 46. In the embodiment shown in FIG. 1, the lower surface of the ribbed portion 64 of the locking lever 30 is contacted by the first bias spring 58, which also contacts the top surface of the upper disc 28.

The first bias spring 58 exerts the bias force, which creates a force moment that pivotally rotates the nose portion 62 of the locking lever 30 downward onto the top surface of upper disc 28. The nose portion 62 engages the notch 65 on the locking pin 32 to transfer the rotational force moment into a linear downward force on the locking pin 32. When the apertures 36, 46 are aligned, the downward bias force moves the locking pin 32 downward inside the locking aperture 46 and into the aligned aperture 36. In one embodiment, the bias force on the pin 22 maintains the locking engagement between the lower disc 26 and the upper disc 28 until the locking pin 32 is actuated out of the aperture 36.

The locking pin 32 may be actuated out of locking engagement by exerting sufficient downward force on the top surface of the ribbed portion 64 to overcome the bias force moment exerted by the first bias spring 58. The actuation force creates a force moment that pivotally rotates the nose portion 62 of the locking lever 30 upward away from the top surface of the upper disc 28. The notch 65 on the locking pin 32 and the nose portion 62 of the locking lever 30 are adapted to transfer the upward movement of the locking lever 30 into linear upward movement of the locking pin 32. The upward movement of the locking pin 32 withdraws the pin 32 from locking engagement with one of the apertures 36, unlocking the upper disc 28 from the lower disc 26. Once the pin 32 has been removed from one of the apertures 36, the upper disc 28 may be rotated on the shoulder bolt 50. This allows the upper disc 28 to be angularly adjusted (swung), and the locking pin 32 actuated into and out of multiple interlocking positions with the apertures 36.

4. Overview of the Pivot Assembly 15 and Latch Assembly 16

The pivot assembly 15 is secured to the upper disc 28. The holder tube 18 pivotally couples to the pivot assembly 15. In one embodiment, this pivot coupling is the generally horizontal pivot axis P of the assembly 10. The latch assembly 16 is pivotally coupled to the holder tube 18 and is biased into engagement with the pivot assembly 15.

In one embodiment, the latch assembly 16 is capable of actuation into and out of locking engagement with the pivot assembly 15 to allow the inclination of the holder tube 18 to be azimuthally adjusted to multiple locking positions about the pivot axis P. In another embodiment, the holder tube 18 may be azimuthally adjusted upward by the angler without actuating the latch assembly 16 out of engagement with the pivot assembly 15. The latch assembly 16 and pivot assembly 15 provide locking resistance when the angler attempts to azimuthally adjust the holder tube 18 downward toward a horizontal holder tube 18 position. In this embodiment, the angler simply grabs the holder tube 18 (or a fishing rod inserted in the holder tube 18) and pulls upward. The angular adjustment of the holder tube 18 in response to the pull keeps tension on the fishing line allowing the fishing hook to: remain set. The angler can pivot the holder tube 18 up and lift the fishing rod out of the assembly 10 in one continuous motion when catching a fish. By allowing the holder tube 18 to be angular adjusted upward without actuating the latch assembly 16, the angler does not have to be concerned about actuating the latch assembly 16 out of locking engagement when the fish strikes. Thus, this embodiment of the assembly 10 further simplifies the fish catching process for the angler and increases the likelihood of catching fish.

5. The Pivot Assembly 15

The pivot base 66 is mounted to the top surface of the upper disc 28, and is symmetrically aligned over the generally vertical axis defined by the shoulder bolt 50. The pivot base 66 extends generally vertically from upper disc 28 and is configured to receive the pivot pin 67. The e-clips 68 and the spacer bushings 70 interface with the pivot pin 67 on the portions of the pin 67 extending between the exterior surfaces of the pivot base 66 and the interior surface of the holder tube 18. The pivot pin 67 pivotally couples the holder tube 18 to the pivot base 66. The pivot pin 67 defines the generally horizontal pivot axis P for the holder tube 18. The e-clips 68 and spacer bushings 70 reduce the side-to-side play of the holder tube 18 on the pivot pin 67.

The pivot base 66 includes the base portion 72 and the upper portion 74. The base portion. 72 has two mounting holes 76, which are aligned with the two counter bored holes 39. The mounting holes 76 receive the two cap screws 40, which secure the pivot base 66 to the upper disc 28. In another embodiment, the mounting holes 76 receive fasteners, which mount the pivot base 66 directly to the vessel surface.

The upper portion 74 extends generally vertically from the base portion 72. The lower section of the upper portion 74 tapers horizontally as the section extends vertically. The upper section of the upper portion 74 cantilevers horizontally outward. The pivot aperture 78 extends generally horizontally through the non-cantilevered upper section of the upper portion 74 and receives the pivot pin 67.

6. The Latching Assembly 16

The cantilevered part of the upper portion 74 of the pivot base 66 is configured with a circumferentially extending row of detents 79. The detents 79 are arrayed along an annular edge of the cantilevered upper portion 74. The detents 79 are arrayed along the generally horizontal pivot axis P of the assembly 10 defined by the pivot aperture 78. The latch lever 80 is contacted by the second bias spring 81, which rotates the latch lever 80 about the latch pivot pin 82 to selectively engage the detents 79.

More specifically, the pivot hole 83 extends through the lower middle of the side surfaces of latch lever 80 and pivotally receives the latch pivot pin 82, which couples the latch lever 80 to the holder tube 18. The upper portion of the latch lever 80 includes the latch handle 81, which extends outward away from the holder tube 18. The pawl 86 projects inwards below the holder tube 18 toward the pivot base 66 from the lower portion of the latch lever 80. The bias force exerted by the second bias spring 81 (disposed between the inner portion of the latch handle 81 and the outer surface of the holder tube 18) results in a force moment that pivotally rotates the pawl 86 downward onto the detents 79 on the upper portion 74. The detents 79 and pawl 86 are configured to create an interlocking engagement between the pivot base 66 and the holder tube 18.

In one embodiment, the bias force on the latch lever 80 maintains the interlocking engagement until the latch lever 80 is actuated out of contact with the detents 79. In another embodiment, the detents 79 are configured act as a ratchet to interlock with the pawl 86 only when the holder tube 18 is pivoted azimuthally downward toward the vessel surface.

In one embodiment of the invention, the detents 79 are configured to act as a ratchet to allow for pivotal movement of the holder tube 18 in one direction without having to actuate the latch lever 80. In this embodiment, the pawl 86 remains in contact with the detents 79 during the adjustment of the inclination of the holder tube 18. The angler simply grabs the holder tube 18 (or a fishing rod inserted in the holder tube 18) and pulls upward. The inclination adjustment of the holder tube 18 in response to the pull keeps tension on the fishing line allowing the fishing hook to remain set. The angler can pivot the holder tube 18 up and lift the fishing rod out of the assembly 10 in one continuous motion when catching a fish. Because the holder tube 18 can be pivoted azimuthally upward without actuating the latch lever 80, the angler does not have to be concerned about actuating the latch lever 80 out of locking engagement when the fish strikes. Thus, this embodiment of the assembly 10 further simplifies the fish catching process for the angler and increases the likelihood of catching fish.

In another embodiment, the latch lever 80 may be actuated out of locking engagement by exerting sufficient force on the exterior surface of the latch handle portion 84 to overcome the bias force. The actuation force creates a force moment that pivotally rotates the pawl 86 of the latch lever 80 outward, away from the detents 79. Once the latch lever 80 has been removed from one of the detents 79, the holder tube 18 may be pivoted about the pivot pin 67. This allows the inclination of the holder tube 18 to be adjusted. Once the desired holder tube 18 inclination is obtained, the latch lever 80 is actuated by the second bias spring 81 into one of the multiple locking positions with the detents 79 to lock the inclination of the holder tube 18.

7. The Holder Tube 18

In FIGS. 1, 1A, and 1B, the holder tube 18 is adapted to receive the pivot pin 67. More specifically, holder tube 18 includes the shaft 88, which is an open frame hollow tubular projection. The open frame shaft 88 is capable of removably receiving a handle or grip portion of a fishing rod. In one embodiment, the shaft 88 is comprised of a metal, such as aluminum. A cantilevered lower portion of the shaft 88 is configured to extend to either side of the upper portion 74. The pivot aperture 90 extends through the open frame of the cantilevered portion to rotatably receive the pivot pin 67. The lower gimbal aperture 92 extends through the open frame of the shaft 88. The lower gimbal aperture 92 receives the lower gimbal pin 94. In one embodiment, the lower gimbal pin 94 acts as an internal stop for the handle portion of the fishing rod within the open frame of the shaft 88.

The shaft 88 extends from the lower cantilevered portion to an upper portion which receives the end cap 96. In one embodiment, the end cap 96 acts as an external stop interfacing with the reel attached to the fishing rod. The lever channel 98 extends the entire length of the shaft 88 from the end cap 96 to the lower end and includes an interior wall and two side walls. In FIG. 1, the upper gimbal aperture 100 extends through the side walls of the lever channel 98 and through the wall of the shaft 88. The upper gimbal aperture 100 receives the upper gimbal pin 102. The upper gimbal pin 102 interfaces with and is a stop for the cosmetic insert 104. The latch lever aperture 106 extends through the side walls of the lever channel 98 and through the wall of the shaft 88. The latch lever aperture 106 receives the latch pivot pin 82, which pivotally couples the latch lever 80 to the holder tube 18. The second bias spring 81 contacts the inner surface of the latch lever 80 and the interior wall of the lever channel 98. The second bias spring 81 exerts a bias force, which pivotally rotates the latch lever 80 away from the second bias spring 81 about the latch pivot pin 82 to engage the pivot base 66. The second bias spring 81 exerts the bias force, which creates a force moment that pivots the pawl 86 downward onto the detents 79 on the upper portion 74 of the pivot base 66.

8. Different Embodiments of the Mounted Assembly 10

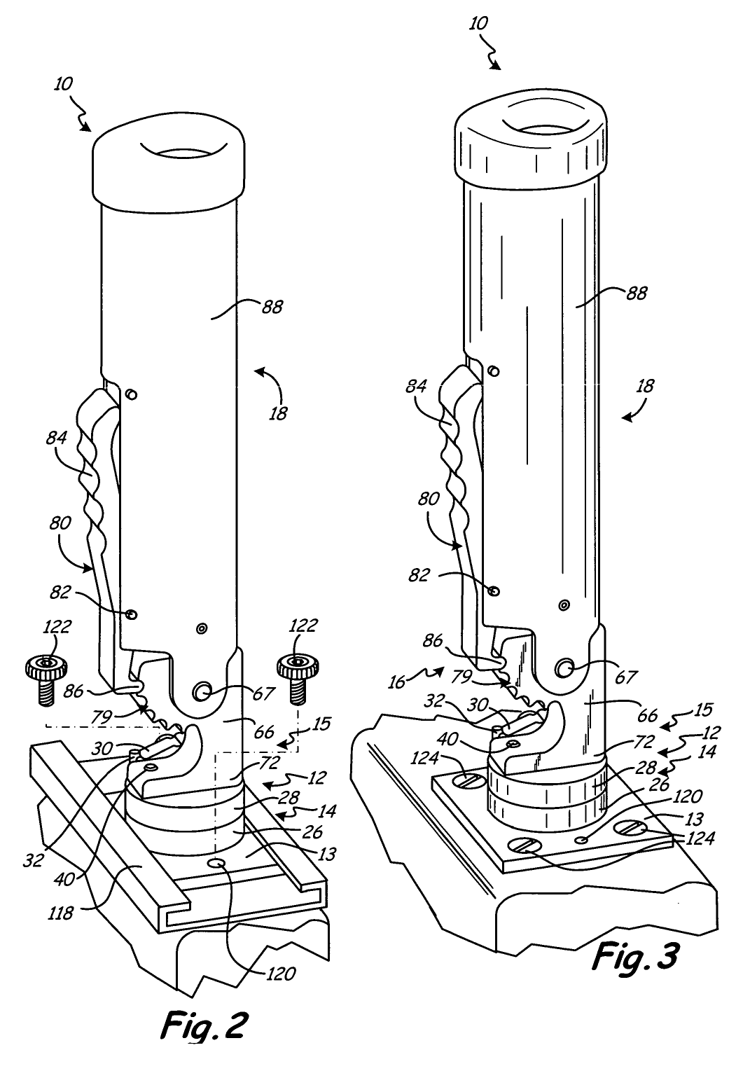

FIG. 2 shows one embodiment of the fishing rod holder assembly 10 mounted to a surface of the fishing vessel. In FIG. 2, the fishing rod holder assembly 10 includes a channel 118, threaded apertures 120, and thumb screws 122. The channel 118 is adapted to mount to any suitable boat surface. For example, the channel 118 may be mounted to the gunnels or transom top by means of adhesives, fasteners, or any other conventional means. The base plate 13 is configured to slidable insert within the channel 118 under flanges. The channel 118 is capable of receiving multiple rod holder assemblies 10 simultaneously. The channel 118 also allows the assemblies 10 to be quickly slidably moved along the length of the channel 118 should fishing conditions dictate.

The base plate 13 is adapted with threaded apertures 120 capable of receiving the thumb screws 122. The thumb screws 122 allow the fishing rod holder assembly 10 to be quickly and easily affixed to the channel 118 by threading the thumb screws 122 through the base plate 13 until the top surface of the base plate 13 makes contact with the flanges. The thumb screws 122 may be quickly loosened, and the fishing rod holder assembly 10 rapidly slidably adjusted within the channel 118, in response to changes in fishing conditions. The ability of the assembly 10 to slide within the channel 118, and the angular adjustability of the assembly 10 about the two axes R and P, allows several fishing rods to be used simultaneously.

FIG. 3 shows the embodiment of the fishing rod holder assembly 10 from FIG. 1 mounted on the vessel surface. The fishing rod holder assembly 10 further includes slotted screws 124. In FIG. 3, the four mounting apertures 20 receive the flathead slotted screws 124, which mount the base plate 13 to the vessel surface. The mounting surfaces of the vessel may be selectively equipped with tapped holes in different locations on the vessel. In addition to being angularly adjustable about two axes, the tapped holes allow the fishing rod holder assembly 10 to be moved to different locations or sides of the vessel. The ability of the assembly 10 to be moved to different locations, and the angular adjustability of the assembly 10 about the two axes R and P, allows several fishing rods to be used simultaneously.

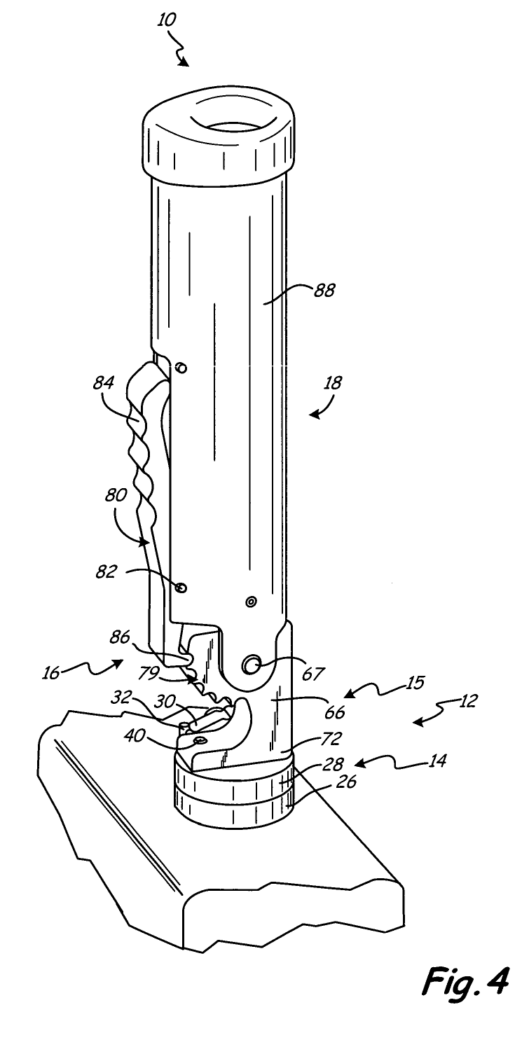

FIG. 4 shows another embodiment of the fishing rod holder assembly, showing the lower disc 26 mounted on the vessel surface. In FIG. 4, the holes 38 receive fasteners, which mount the lower disc 26 directly to the vessel surface. The mounting surfaces of the vessel may be selectively equipped with tapped holes in different locations on the vessel. In addition to being angularly adjustable about two axes, the tapped holes allow the fishing rod holder assembly 10 to be moved to different locations or sides of the vessel.

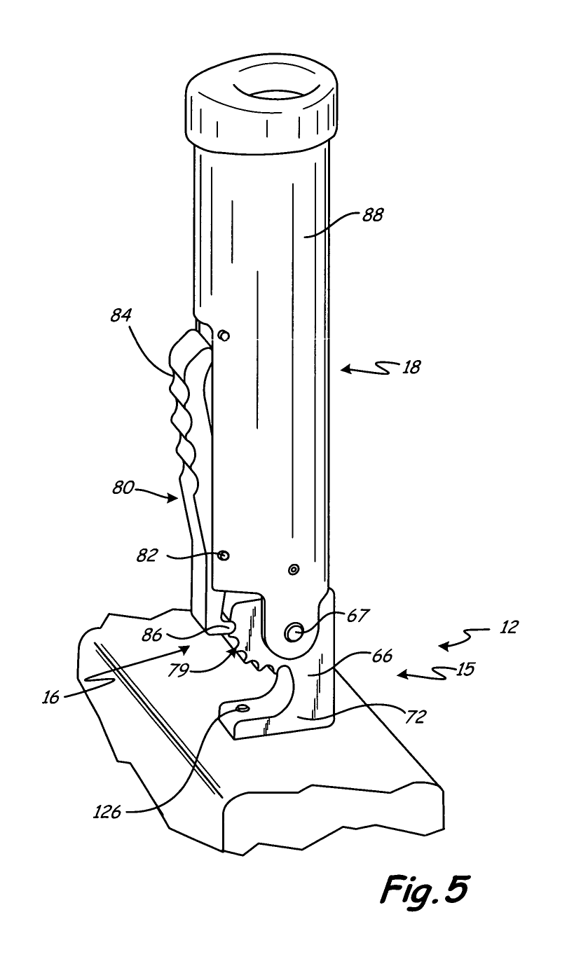

FIG. 5 shows yet another embodiment of the fishing rod holder assembly 10 mounted on the vessel surface. In FIG. 5, the fishing rod holder assembly 10 includes screws 126. The base portion 72 of the pivot base 66 is configured to be mounted directly to the surface of the vessel. More specifically, the base portion 72 has tapped mounting holes 76 capable receiving the threaded portion of the screws 126. In the embodiment shown, the screws 126 are inserted through holes tapped through from the back side of the mounting surface. In this configuration, the head of the screw 126 interfaces with the back side of the mounting surface. In other embodiments of the invention, a bolt, bracket or adhesive fastener may be used to mount the pivot base 66 to the vessel surface from either the front or back side. The latch lever 80 and the circumferentially extending row of detents 79 shown in FIG. 5 allow the holder tube 18 to be smoothly, easily and securely adjusted to multiple locking positions with the pivot base 66. The surfaces of the vessel may be selectively equipped with tapped holes in different mounting locations on the vessel. The tapped holes allow the fishing rod holder assembly 10 to be moved to different locations or sides of the vessel.

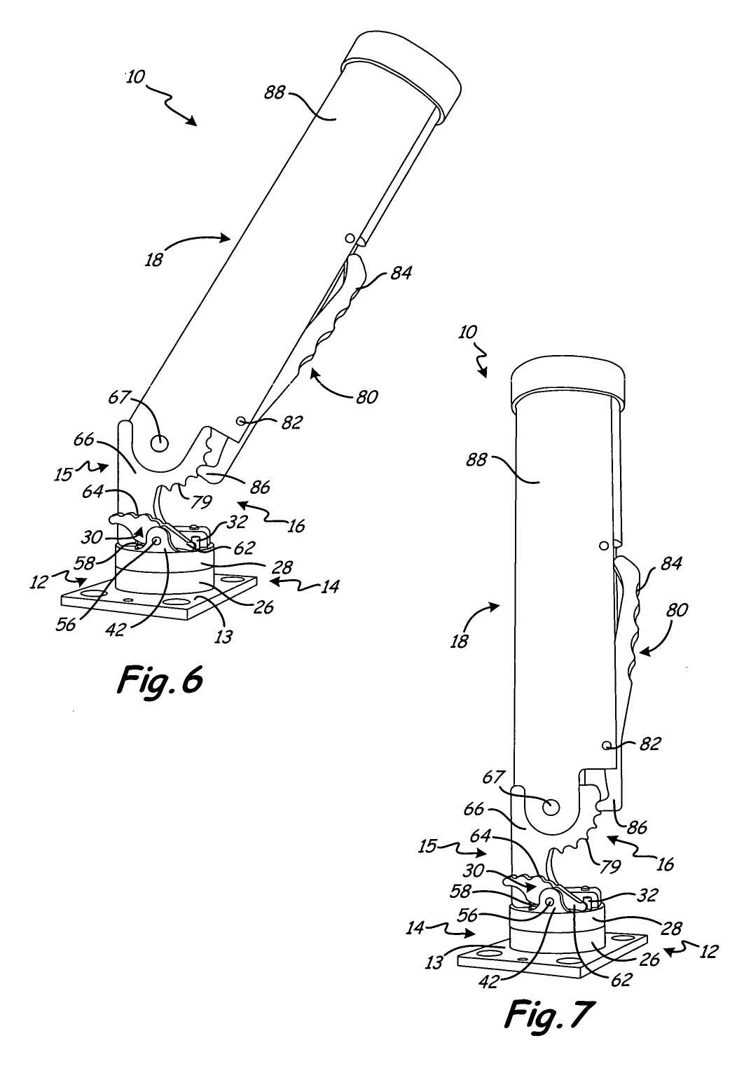

FIGS. 6 and 7 show one embodiment of the fishing rod holder assembly 10 in two interlocked positions. In FIG. 6, the fishing rod holder assembly 10 is at an angle of inclination between its horizontal and vertical pivotal range. From this interlocked position, the assembly 10 can be smoothly, easily, and quickly rotated about the generally vertical rotational axis R defined by the shoulder bolt 50 by actuating the locking lever 30 to raise the locking pin 32.

FIGS. 6 and 7 better illustrate the interconnection between the locking lever 30 and the locking pin 32. In FIGS. 6 and 7, the nose portion 62 engages the notch 65 on the locking pin 32 to transfer the rotational force moment exerted by the first bias spring 58 into a linear downward force on the locking pin 32. When the apertures 36, 46 are aligned, the downward bias force moves the locking pin 32 downward inside the locking aperture 46 and into the aligned aperture 36 (FIG. 1) to lock the upper disc 28 to the lower disc 26. The locking pin 32 may be actuated out of locking engagement by exerting sufficient downward force on the top surface of the ribbed portion 64 to pivotally rotate the nose portion 62 of the locking lever 30 upward. The notch 65 on the locking pin 32 and the nose portion 62 of the locking lever 30 are adapted to transfer the upward movement of the locking lever 30 into linear upward movement of the locking pin 32. The upward movement of the locking pin 32 withdraws the pin 32 from locking engagement with one of the apertures 36 (FIG. 1), unlocking the upper disc 28 from the lower disc 26.

In a first embodiment, the holder tube 18 may be horizontally angularly adjusted from the locking position in FIG. 6, to the vertical locking position in FIG. 7, by manually rotating the holder tube 18 toward the vertical locking position without actuating the latch lever 80. In this embodiment, the pawl 86 of the latch lever 80 is configured as a pawl, and the detents 79 are configured as a ratchet. The pawl 86 remains in contact with the detents 79 during the angular adjustment of the holder tube 18. The angler simply grabs the holder tube 18 (or a fishing rod inserted in the holder tube 18) and pulls upward. The angular adjustment of the holder tube 18 in response to the pull keeps tension on the fishing line allowing the fishing hook to remain set. The angler can pivot the holder tube 18 up and lift the fishing rod out of the assembly 10 in one continuous motion when catching a fish. By allowing the holder tube 18 to be angular adjusted upward without actuating the latch lever 80, the angler does not have to be concerned about actuating the latch lever 80 out of locking engagement when the fish strikes. Thus, this embodiment of the assembly 10 further simplifies the fish catching process for the angler and increases the likelihood of catching fish.

Alternatively, the holder tube 18 also may angularly adjusted by actuating the latch lever 80 from locking engagement with the circumferentially extending row of detents 79 on the pivot base 66. The holder tube 18 may then be pivotally adjusted to the desired position and the latch lever 80 actuated or biased into engagement with the detents 79 to lock the holder tube 18 azimuthally.

Although the present invention has been described with reference to preferred embodiments, workers skilled in the art will recognize that changes may be made in form and detail without departing from the spirit and scope of the invention.

1. An adjustable fishing rod holder assembly, the assembly comprising:
a base assembly adapted to be mounted to a surface;
a holder configured to removably receive a portion of a fishing rod and pivotally coupled to the base assembly for adjustment of an inclination angle; and
a latch assembly configured to lock the holder in multiple inclination angle positions with respect to the base assembly.

2. The adjustable fishing rod holder assembly of claim 1, wherein the base assembly comprises:
a pivot assembly having an upper portion pivotally connected to the holder and defining a pivot axis of the holder.

3. The adjustable fishing rod holder assembly of claim 2, wherein the base assembly comprises:
a rotational assembly secured to a lower portion of the pivot assembly and defining a rotational axis of the holder, the assembly adapted to swing the holder to multiple locking positions.

4. The adjustable fishing rod holder assembly of claim 3, further comprising a base plate adapted to secure to a lower end of the rotational assembly.

5. The adjustable fishing rod holder assembly of claim 2, wherein the wherein the rotational assembly comprises:
a lower puck defining the rotational axis and having circumferentially arrayed apertures;
an upper puck mounted to the lower puck and adjustable with respect to the lower puck about the rotational axis;
a locking lever pivotally coupled to the upper puck; and
a locking pin engaging the locking lever and capable of actuation into and out of locking engagement with the aperture in the lower puck to restrain or allow for rotational adjustment of the upper puck.

6. The adjustable fishing rod holder assembly of claim 5, further comprising a second spring which biases the locking lever to actuate the locking pin into locking engagement with the aperture in the lower puck.

7. The adjustable fishing rod holder assembly of claim 5, further comprising a trunnion which rotatably interfaces the upper puck and is secured to the lower puck to define the rotational axis about which the upper puck rotates.

8. The adjustable fishing rod holder of claim 1, wherein the latch assembly comprises:
a circumferential array of detents disposed generally at or below the pivot coupling between the holder and the base assembly;
a bias spring; and
a latch lever has an upper portion adapted as a handle and a lower portion which engages the detents, the latch lever is pivotally coupled to a side surface of the holder and biased by the bias spring longitudinally downward and inward into engagement with the detents to lock the holder in multiple inclination angle positions.

9. The adjustable fishing rod holder assembly of claim 8, wherein the lower portion of the latch lever is configured with a pawl which extends generally inward toward the base assembly and the detents are configured as a ratchet to allow the holder to be manually inclined azimuthally upward from the base assembly without manually actuating the latch lever out of engagement with the detents.

10. The adjustable fishing rod holder assembly of claim 8, wherein the latch lever is capable of actuation out of engagement with the detents to unlock the holder and allow for adjustment of the inclination angle of the holder.

11. The adjustable fishing rod holder assembly of claim 1, wherein the holder comprises:
an open frame longitudinally extending hollow tubular shaft has an outer surface channel adapted to receive a portion of the latch assembly and a lower portion pivotally coupled to an upper portion of the base assembly.

12. An adjustable fishing rod holder assembly, the assembly comprising:
a lower disc defining a rotational axis and having circumferentially arrayed apertures;
an upper disc mounted to the lower disc and adjustable with respect to the lower disc about the rotational axis;
a locking lever pivotally coupled to the upper disc;
a bias spring;
a locking pin engaging the locking lever and biased by the bias spring into locking engagement with the aperture in the lower disc, the pin capable of manual actuation out of locking engagement to allow for rotational adjustment of the upper disc;
a pivot base mounted to a top surface of the upper disc and defining a pivot axis;
a holder configured to removably receive a portion of a fishing rod and pivotally coupled to an upper portion of the pivot base for adjustment of an inclination angle;
a circumferential array of detents disposed generally at or below the pivot axis;
a second bias spring; and
a latch lever has an upper portion adapted as a handle and a lower portion which engages the detents on the pivot base, the latch lever is pivotally coupled to a side surface of the holder and biased by the second bias spring longitudinally downward and inward into engagement with the detents to lock the holder in multiple inclination angle positions.

13. The adjustable fishing rod holder assembly of claim 12, further comprising a base plate adapted to secure to a bottom surface of the lower disc.

14. The adjustable fishing rod holder assembly of claim 13, further comprising a channel adapted to be mounted to a surface and configured so as to permit the base plate to be slidably inserted within and fastened to the channel.

15. The adjustable fishing rod holder assembly of claim 12, wherein the lower portion of the latch lever is configured with a pawl which extends generally inward toward the pivot base and the detents are configured as a ratchet to allow the holder to be manually inclined azimuthally upward from the pivot base without manually actuating the latch lever out of engagement with the detents.

16. An adjustable fishing rod assembly, the assembly comprising:
a first puck adapted to be mounted to a surface;
a second puck interfacing the first puck;
a pivot bracket mounted to the top of the second puck;
a holder pivotally coupled to the bracket and capable of removably receiving a portion of a fishing rod;
means for angularly adjusting the second puck relative to the first puck about a rotational axis;
means for interlocking the second puck with the first puck in multiple interlocking positions;
means for angularly adjusting the holder relative to the pivot bracket about a pivot axis; and
means for interlocking the holder with the pivot bracket in multiple interlocking positions.

17. The adjustable fishing rod holder assembly of claim 16, further comprising a base plate adapted to mount to a surface.

18. The adjustable fishing rod holder assembly of claim 16, wherein the means for interlocking the second puck with the first puck in multiple interlocking positions comprises:
a locking lever pivotally coupled to the upper puck;
a bias spring;
a locking pin engaging the locking lever and biased by the bias spring into locking engagement with an aperture in the lower puck, the pin capable of manual actuation out of locking engagement to allow for rotational adjustment of the upper puck to multiple interlocking positions.

19. The adjustable fishing rod holder assembly of claim 16, wherein the means for angularly adjusting the second puck relative to the first puck about a rotational axis comprises:
a trunnion which rotatably interfaces the upper puck and is secured to the lower puck to define the rotational axis about which the upper puck rotates.

20. The adjustable fishing rod holder assembly of claim 16, wherein the means for interlocking the holder with the pivot bracket in multiple interlocking positions comprises:
a circumferential array of detents disposed generally at or below the pivot axis;
a bias spring; and
a latch lever has an upper portion adapted as a handle and a lower portion which engages the detents, the latch lever is pivotally coupled to a side surface of the holder and biased by the bias spring longitudinally downward and inward into engagement with the detents to lock the holder in multiple interlocking positions.

21. The adjustable fishing rod holder assembly of claim 20, wherein the lower portion of the latch lever is configured with a pawl which extends generally inward toward the pivot bracket and the detents are configured as a ratchet to allow the holder to be manually inclined azimuthally upward from the pivot bracket without manually actuating the latch lever out of engagement with the detents.
